(19) United States
(12) Patent Application Publication
(10) Pub. No.: US 2008/0037689 A1
(43) Pub. Date: Feb. 14, 2008

(54) Adaptive Kalman filtering for fast fading removal

(76) Inventors: Tolga Kurt, Ottowa (CA); Yann Le Helloco, Ottowa (CA)

Correspondence Address: NIXON & VANDERHYE, PC, 901 NORTH GLEBE ROAD, 11TH FLOOR, ARLINGTON, VA, 22203, US

(21) Appl. No.: 11/642,969

(22) Filed: Dec. 21, 2006

Related U.S. Application Data
(60) Provisional application No. 60/836,376, filed on Aug. 9, 2006.

(51) Int. Cl. H04L 27/06

(52) U.S. Cl. 375/340

(57) ABSTRACT

An adaptive Kalman filtering method and apparatus are used to process signal measurement data associated with the received radio signal. The signal measurement data includes a fast fading component and a slow fading component. The adaptive Kalman filtering process filters out the fast fading component of the signal measurement data but preserves to a large extent the slow fading components. This approach significantly improves the accuracy of the signal strength estimation and fast fading removal while at the same time significantly reduces the number of actual data samples required to remove that fast fading from the signal measurement data. This relaxes the speed and density requirements of the signal measurements, which in turn save time and costs.

### RELATED APPLICATION

This application claims the priority and benefit of U.S. Provisional patent application 60/836,376, filed Aug. 9, 2006, which is incorporated herein by reference in its entirety.

### TECHNICAL FIELD

The technical field relates to accurately estimating received signal strength. In one non-limiting example application, the technology described here may be used in efficiently and accurately processing autonomous drive test data (ADT) as well as non-autonomous drive test data (NADT).

### BACKGROUND

In radio communications, it is important to obtain accurate measurements of signal strength (or some other measure of signal quality) or path loss between a radio transmitter and a radio receiver. Indeed, in the management of modern radio communications networks, operators are very interested in obtaining accurate signal strength measurement from various points in a geographical area for which coverage is provided. For example, a coverage area like a cell includes one or more base stations that transmit some sort of recognizable signal at a known power level.

FIG. 1 illustrates an example cellular radio communication system 10 with a simplified number of three geographical coverage areas: cell 1, cell 2, and cell 3. Each cell includes a respective base station BS1, BS2, and BS3. The various “X's” in the cell correspond to locations in which the signal strength of a signal transmitted from the corresponding base station is received at that location. The signal strength detection can be performed using special vehicles having radio transceivers that move about the various cell areas recording signal strengths at specific times at specific locations. Alternatively, this signal strength data can be obtained less systematically using signal strength measurements made by various mobile radio terminals that subscribe to cellular radio service, sometimes referred to as user equipments (UEs). This signal strength data obtained for a radio communication system is referred to herein as autonomous drive test (ADT) data.

This type of signal strength data automatically obtained for various locations in a communications network is important for a number of reasons relating to the management of that network. The ADT data can be used to track and optimize the air interface performance of the network at various locations and detect problems on a regular basis at a low cost. Virtual surveys can also be designed and implemented. Radio signal propagation models and antenna patterns can be determined and optimized on a per cell basis. This kind of ADT data may even be used in self-optimizing networks.

But none of these management operations can be properly performed if the measured signal strength data is not accurately obtained and processed. Network operators often employ analytical radio path propagation models as well as empirical radio path propagation models to make predictions in order to help them operate the radio network more optimally. Most of these prediction processes rely on the comparison of measured signal strength data and the actual prediction results to optimize a set of propagation model and input parameters. But prior to comparison, the measured signal level should be filtered in order to remove some effects that will not be simulated by the propagation model. One of the most important effects that need to be cancelled out is small scale or fast fading, which is either Rician or Rayleigh distributed depending on the line of site conditions. The measured signal strength data typically includes three components: log-normal or slow fading, fast fading, and additive Gaussian noise. The objective is to filter out the fast fading components of the signal strength measurements but still retain the slow fading components.

FIG. 2 illustrates in a general way a network management system 12. A signal strength processor 14 receives a large volume of signal strength measurements and must process those signal strength measurements to ensure that they are accurate and that certain undesirable components of the signal, such as fast fading components, are removed before the processed measurements are then provided to the network management node 16 to perform the network management functions based on processed signal strength measurement data.

FIG. 3 is a graph that illustrates the signal level of signal strength measurement data over time. It is readily apparent that while the average signal strength is near ‘−35 dBm’, the fast fading components of the signal make the signal change vary dramatically between ‘−27 dBm’ and ‘−70 dBm’ very rapidly and nearly continuously. So it is clear that fast fading components can greatly affect the signal strength measurement data if not removed or accounted for.

Most fast fading cancellation or filtering techniques perform a time-windowed average of the signal samples or evaluate the median of the signal strength values using a time window. But there are significant problems with window-based approaches. In all the window-based approaches, a difficulty is defining the optimum window length or shape for a set of signal strength data being analyzed. This problem can be seen in the signal strength level versus distance graph shown in FIG. 4. When the median value of the signal is determined for a particular window size, it is evident that the determined median signal does not accurately track the actual signal. In other words, the dashed line substantially “ignores” significant peaks and valleys in the actual signal. Another problem is the large number of samples, and thus memory and processing time/resources, needed to support window-based approaches.

A static Kalman filter could be used to remove fast fading. A Kalman filter is a time domain filter that performs a point-by-point analysis. Only the estimated signal strength (corresponding to an estimated state) from the previous time step and the current signal measurement are needed to compute an estimate for the current signal strength state. No window or history of measurements is required. A problem with a static Kalman filtering approach is the need to make some significant assumptions, that in practice, are not always true. For example, a static Kalman approach must assume the following to be known: the variance of the slow fading of the received signal strength data, the variance of the fast fading of the received signal strength data, and a correlation coefficient between consecutive samples of the received signal strength data. The average of the signal strength data is also assumed to be zero dB, which usually is not the case. Moreover, the fast and slow variances and the correlation coefficient are not static, and much better results would be achieved if they could be estimated dynamically for each signal strength measurement. The inventors realized that since Kalman filter parameters can be estimated prior to the application of the Kalman filter, an adaptive Kalman filtering approach would be ideal.

### SUMMARY

An adaptive Kalman filtering method and apparatus are used to process signal measurement data associated with the received radio signal. The signal measurement data includes a fast fading component and a slow fading component. The adaptive Kalman filtering process filters out the fast fading component of the signal measurement data but preserves to a large extent the slow fading components. This approach significantly improves the accuracy of the signal strength estimation and fast fading removal while at the same time significantly reduces the number of actual data samples required to remove that fast fading from the signal measurement data. This relaxes the speed and density requirements of the signal measurements, which in turn save time and costs.

Initially, the measurement data is processed and used to calculate one or more filtering variables. The measurement data is then Kalman-filtered using the estimated one or more filtering variables. Ultimately, the Kalman-filtered measurement data is used to manage a communications network. In a preferred, non-limiting example embodiment, the signal measurement data includes the signal strength of received radio signals at multiple different geographical positions in a radio communications system. Example management applications include (but are not limited to) determining a direction of arrival information for the received radio signals at the multiple different geographical positions, adapting a modulation method and/or a coding method used to transmit signals to the multiple different geographical positions, and control transmit power levels used to transmit radio signals to the multiple different geographical positions.

In a preferred, non-limiting embodiment, the adaptive Kalman filtering process is an iterative process and uses multiple Kalman filter variables whose values are estimated based on the signal measurements. Thus, an estimate of the multiple Kalman filtering variables is determined for each iteration. The multiple Kalman filtering variables include a variance of a slow fading component of the signal measurement data, and variance of a fast fading component of the signal measurement data, and a correlation coefficient associated with a degree of correlation between signal measurement data at each geographical position at a first time and signal measurement data at that same geographical position at a second time.

Another desirable aspect that may be employed in the adaptive Kalman filtering process adapts a Kalman-filtered result using estimated changes in the fast fading component over predetermined period using a windowing technique. In essence, low frequency components of the Kalman-filtered data are replaced with low frequency components in the original measurement data. The inventors discovered that this low frequency replacement improves the performance of the adaptive Kalman filtering process.

In one non-limiting, example embodiment, the Kalman filtering process may be performed using the following steps. First, an a priori estimate of the signal strength at each of the geographical positions is determined based on a previously-determined signal strength at each of the geographical positions. Second, an a posteriori prediction of the minimum means square error (MMSE) is determined of a previous determination of a signal strength at each of the geographical positions based on variances and power levels of fast and slow fading of the signal strength data. Third, Kalman filtering gain is then determined based on the determined a posteriori prediction of MMSE and an estimate of a variance of the fast fading component. Fourth, a Kalman filtering output is determined based on the a priori estimate, the Kalman filtering gain, and an average signal strength of the received radio signal at multiple geographical positions.

### BRIEF DESCRIPTION OF THE DRAWINGS

FIG. 1 illustrates an example cellular radio communications system;

FIG. 2 illustrates a system for processing large volumes of signal strength measurements and using those processed measurements in network management function;

FIG. 3 is a graph of signal level versus time illustrating the fading of a mobile channel for a user moving at 30 kph;

FIG. 4 is a graph illustrating signal level versus distance illustrating both the signal strength samples and a median value;

FIG. 5 is a function block diagram of the signal strength measurements processor shown in FIG. 2;

FIG. 6 is a flow chart illustrating non-limiting, example procedures for an adaptive Kalman filtering process;

FIG. 7 is a flow chart that illustrates non-limiting example steps for implementing a Kalman filter in accordance with the adaptive Kalman filtering procedures outlined in FIG. 6;

FIGS. 8A-8D illustrate frequency power spectrums;

FIG. 9 illustrates a graph comparing signal strength data, a median of that data, and a Kalman-filtered version of that data;

FIG. 10 illustrates a magnified excerpt of the graph shown in FIG. 9;

FIG. 11 is a graph illustrating the standard deviation for a number of samples required for a window-based, median filtering approach and an adaptive Kalman filtering approach for processing signal strength data;

FIG. 12 is a function block diagram of a non-limiting example embodiment of a signal strength measurements processor such as that shown in FIG. 2;

FIG. 13 illustrates an example application of the adaptive Kalman filtering for estimating direction of arrival information;

FIG. 14 is another example application of adaptive Kalman filtering used to adapt modulation scheme and/or coding level; and

FIG. 15 illustrates an example application of adaptive Kalman filtering to transmission power control.

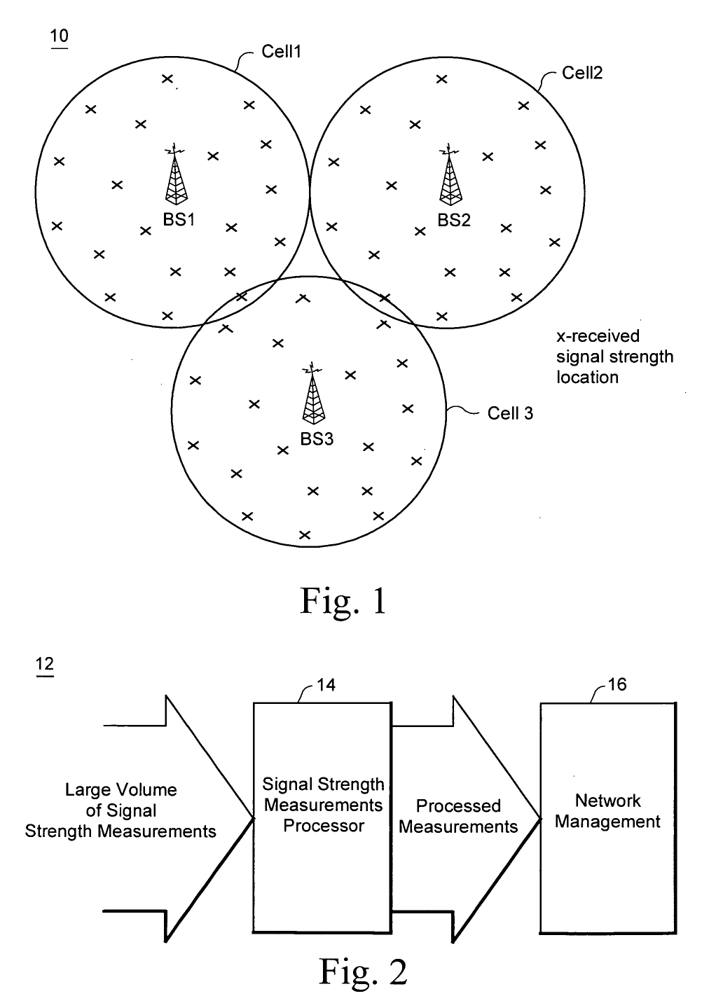

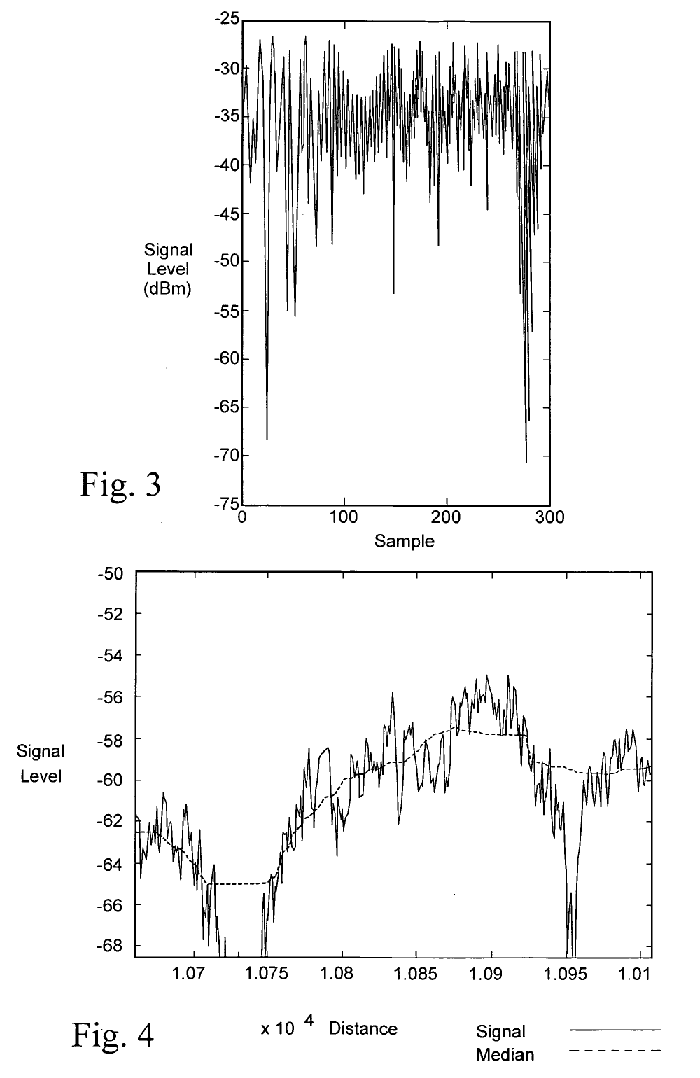

### DETAILED DESCRIPTION

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details disclosed below. For example, while example embodiments are described in the context of signal strength measurements obtained from different geographical locations in a particular coverage area, e.g., one or more cells, the disclosed technology may also be applied to filtering any measurement parameter associated with a received radio signal. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs).

In general, the Kalman filter estimates a process state using a form of feedback control. The filter estimates the process state at some time and then obtains feedback in the form of state measurements. As such, the basic equations for the Kalman filter fall into two groups: time update equations and measurement update equations. The time update equations project forward in time the current state and error covariance estimates to obtain the a priori estimates for the next time step. The measurement update equations provide feedback to incorporate a new measurement into the a priori estimate to obtain an improved a posteriori estimate. The time update equations can be thought of as predictor equations, while the measurement update equations can be thought of as corrector equations. In the ongoing Kalman filtering cycle, the time update projects current state estimate ahead in time. The measurement update then adjusts or corrects the projected estimate by an actual measurement at that time.

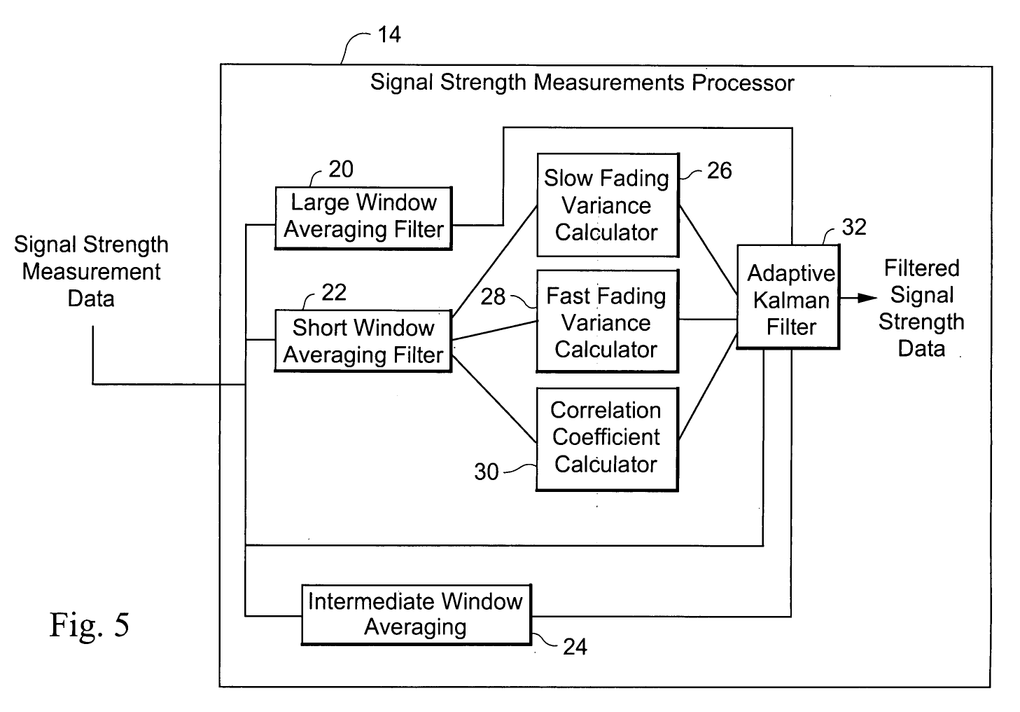

A signal strength measurements processor, such as processor 14 shown in FIG. 2, that implements a non-limiting, example of adaptive Kalman filtering is now described in conjunction with the function block diagram in FIG. 5. Signal strength measurement data from a variety of geographical locations in a radio communications coverage area are provided to a large window averaging filter 20, a short window averaging filter 22, and an intermediate window averaging filter 24. The filtered signal strength data from the large window averaging filter 20 is provided directly to an adaptive Kalman filter 32 as is the output of the intermediate window averaging filter 24. The output data of the short window averaging filter 22, which is similar to a window-based median filter described in the background, are provided to three calculators: a slow fading variance calculator 26, a fast fading variance calculator 28, and a correlation coefficient calculator 30. The outputs of each of the three calculators 26, 28 and 30 are provided to the adaptive Kalman filter. The combined inputs are processed by the adaptive Kalman filter 32 which generates a filtered set of signal strength data that does not rely upon a window-based approach to remove fast fading. As a result, the adaptive Kalman filtering does not suffer the reduced performance associated with using non-optimal averaging windows.

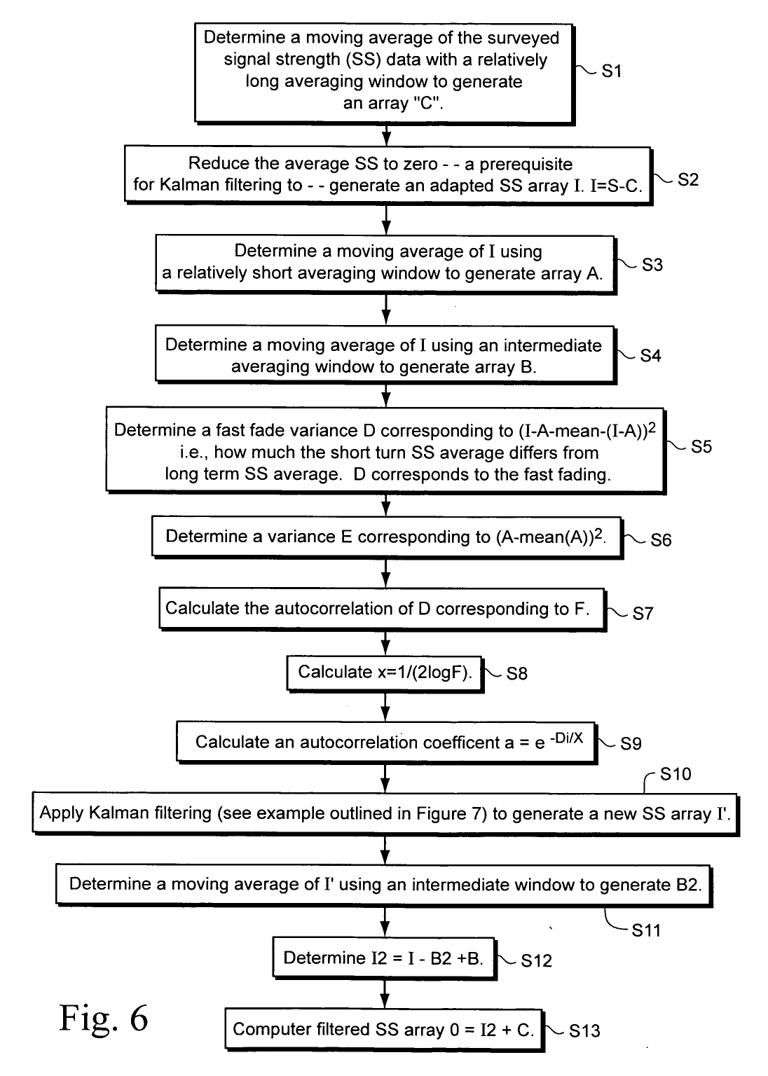

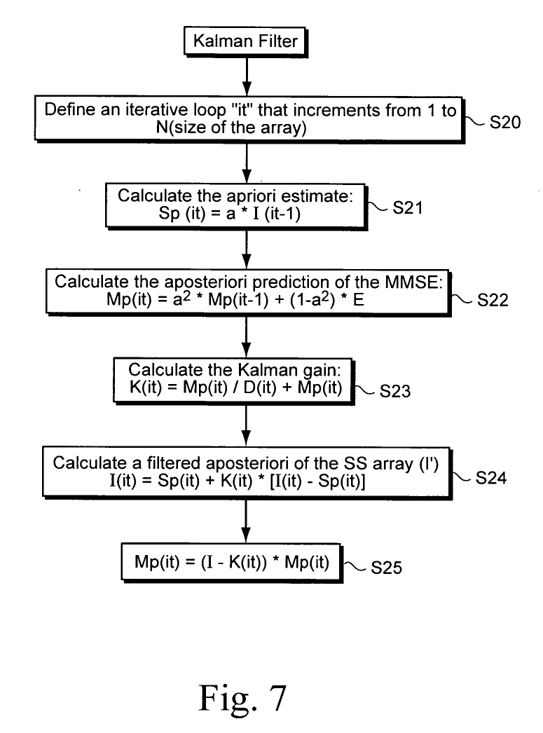

A non-limiting, example adaptive Kalman filtering process that may be employed by the adaptive Kalman filter 32 is now described in conjunction with the flowcharts in FIGS. 6 and 7. FIG. 6 starts with an array S of signal strength values received at various geographical locations. Each geographical location typically has many associated signal strength measurements made at different times. The array S is based on signal strength measurement data provided, in one example application, as a result of ADT or some other type of communications network survey. The goal is to generate another array O of signal strength values but with fast fading components filtered out.

First, a moving averaging of the surveyed data in array S is determined for a relatively long window to generate an array C (step S1). In one non-limiting example, the relatively long window might be on the order of 6000 wavelengths of the received radio signal. Wavelength is used as the window measure in order to make the measurement “distance” independent of wavelength. In other words, the same number of data samples are averaged for the same number of wavelength changes. The data in array C corresponds to the average signal strength of the surveyed data over a large time scale.

Kalman filtering requires that the average expected signal strength be reduced to 0 dBm. But as mentioned in the background, this condition is usually not satisfied in signal strength measurement situations, i.e., the average signal strength is usually not zero. Consequently, the average signal strength values in the data array C are subtracted from the initial data array S to produce an adapted average signal strength array I (step S2) that has an average signal strength of approximately 0 dBm.

A moving average of a portion of the adapted average signal strength array I is determined over a portion window with a relatively short length to generate a median data array A (step S3). Continuing with wavelength as the unit of window length, a non-limiting example of a relatively short window length might be on the order of 40 wavelengths. Step S3 is similar to the window-based median or average filtering described in the background.

A moving averaging window of the adapted average signal strength array I is determined over a window with an intermediate length to generate a new data array B1 (step S4). Continuing with wavelength as the units of window measurement, a non-limiting example of a relatively short window length might be on the order of 500 wavelengths. The data array B 1 can be viewed as a low pass filtered version of the adapted average signal strength array I without any fast fading components and with possibly some but not all of the slow fading components removed. The low pass filtered data are used to adjust the Kalman filtered result to improve the accuracy and performance of the filtering process.

Next, several Kalman filtering parameters are estimated based on the current signal strength measurement data. In static Kalman filtering, these Kalman filtering parameters would be assumed to be constant, even though in real world applications, that those parameter values change with time and/or geography. One example of such a variable Kalman filtering parameter is a fast fading variance of the median data array A. The fast fading variance D of the short term median data array A is determined by subtracting A from the long term average or median data array I (step S5). D can be determined in accordance with the following: D=(I-A-mean(I-A))². Another variable Kalman filtering parameter is a slow fading variance E of the median data array A which is determined in step S6. In other words, E is an estimate of the median data variance without fast fading. E can be determined in accordance with the following: E=(A-mean(A))².

Another variable Kalman filtering parameter is a correlation coefficient parameter. The signal measurement data includes signal measurement data associated with a radio signal received at multiple different geographical positions. The correlation coefficient parameter represents a degree of correlation between signal measurement data at each geographical position at a first time and signal measurement data at that geographical position at a second time. That correlation coefficient is determined in several steps. First, the autocorrelation F of the fast fading variance D is determined (step S7). Then, a variable X can be determined in accordance with the following: X=1/(2LogF) in order to identify the cross-correlation coefficient. X is then used to calculate the correlation coefficient “a” in step S9. As one example, “a” can be determined in accordance with the following: a=e^{-Di/X}, where Di is the distance in wavelength between the signal strength measurements.

Kalman filtering is then performed on the measurement data I to produce a new measurement data array I′ using the procedures described in conjunction with FIG. 7 below (step S10). A moving average of I′ is determined in step S11 over a window with an intermediate length to generate a new data array B2. As in step S4, a non-limiting example of an intermediate window length might be on the order of 500 wavelengths. The data array B2 can be viewed as a low pass-filtered version of the new signal strength array I′ without any fast fading components and with even some but not all of the slow fading components removed. The Kalman-filtered data I2 is then calculated by removing B1 and replacing it with B2 (step S13). Specifically, I2=I−B2+B. The inventors discovered that the low-pass component of the Kalman filter performs poorly and that improved performance may be achieved if it is replaced. Then, to offset the subtraction in step S2, the previously-determined (typically non-zero) average signal strength is added back to generate the Kalman-filtered output array O=I2+C.

FIG. 7 illustrates a flowchart with example, non-limiting procedures for implementing Kalman filtering in step S10 of FIG. 6. An iterative loop variable ‘it’ is defined that changes from 1 to N (size of the array) in step S20. An a priori estimate Sp(it) of the signal strength value at a current location, is determined in step S21 as follows:

Sp(it)=a*I(it−1).

An a posteriori prediction of minimum mean squared error (MMSE), Mp(it), of the signal strength estimation is determined in step S22 as follows:

Mp(it)=a²*Mp(it−1)+(1−a²)*E.

A Kalman gain K(it) is determined in step S23 as follows:

K(it)=Mp(it)/(D(it)+Mp(it)).

A filtered a posteriori estimate I(it) of the signal strength is determined in step S24 as follows:

I(it)=Sp(it)+K(it)*(I(it)−Sp(it)).

An a priori MMSE of the signal strength estimation for the next iteration is determined in step S25 as follows:

Mp(it)=(1−K(it))*Mp(it).

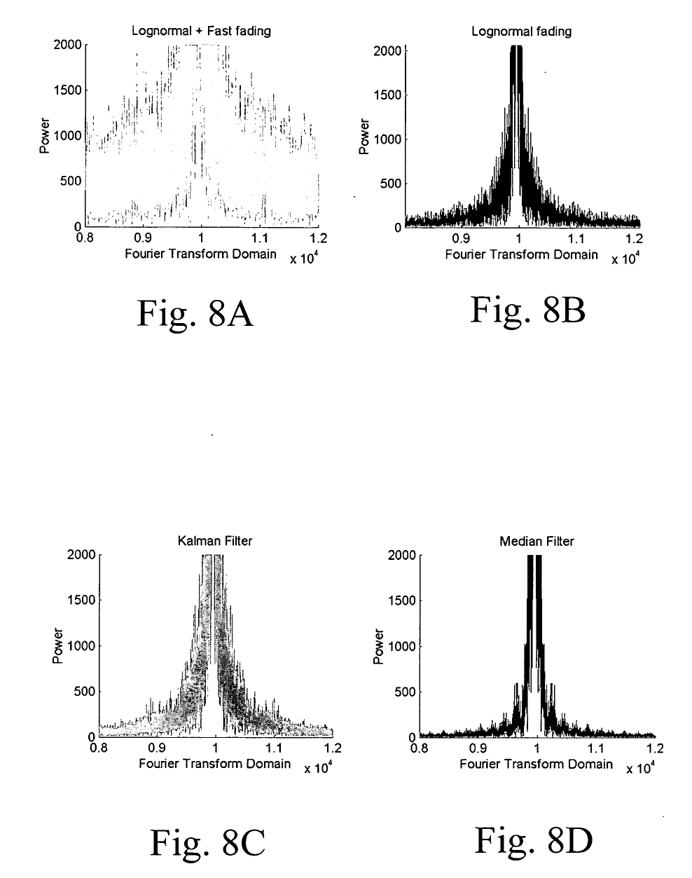

The graphs in FIGS. 8A-8D help illustrate why the adaptive Kalman filtering is a better approach for filtering signal strength data than traditional windowing approaches. FIG. 8A is a graph that illustrates the frequency spectrum of measured signal strength data prior to filtering. The measured signal strength data includes both slow fading components (referred to as log normal fading) and fast fading components. A typically desirable objective is to filter this signal strength data in FIG. 8A to obtain just the slow fading components of that data, illustrated as the log normal fading spectrum shown in the graph of FIG. 8B. If a traditional window-based median filter is used to remove the fast fading components of the signal strength data from FIG. 8A, a frequency spectrum waveform similar to that shown in FIG. 8C is obtained. Comparing the spectrum of FIG. 8C with the desired spectrum in FIG. 8B, it is apparent that some of the important slow fading characteristics of the signal have been removed, which means that the median-filtered signal strength data does not very accurately represent the actual slow fading components of the signal strength data.

In many network management applications, more accurately filtered signal strength data is desirable. For example, because transmission properties, such as modulation/coding and power, should be arranged according to the long term characteristics of the signal rather than the short term. The long term characteristics are presented better by the filtered signal. FIG. 8D shows the results of adaptive Kalman filtering the signal strength data in FIG. 8A. The resulting frequency spectrum shown in FIG. 8D is much closer to the desired log normal fading spectrum shown in FIG. 8B. Thus, it is apparent that the adaptive Kalman filtering approach provides superior filtering performance in terms of accuracy as compared to the median filter approach.

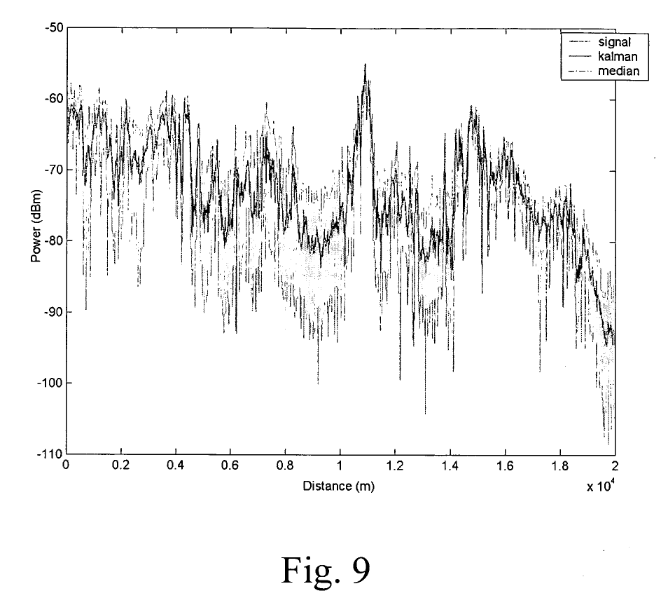

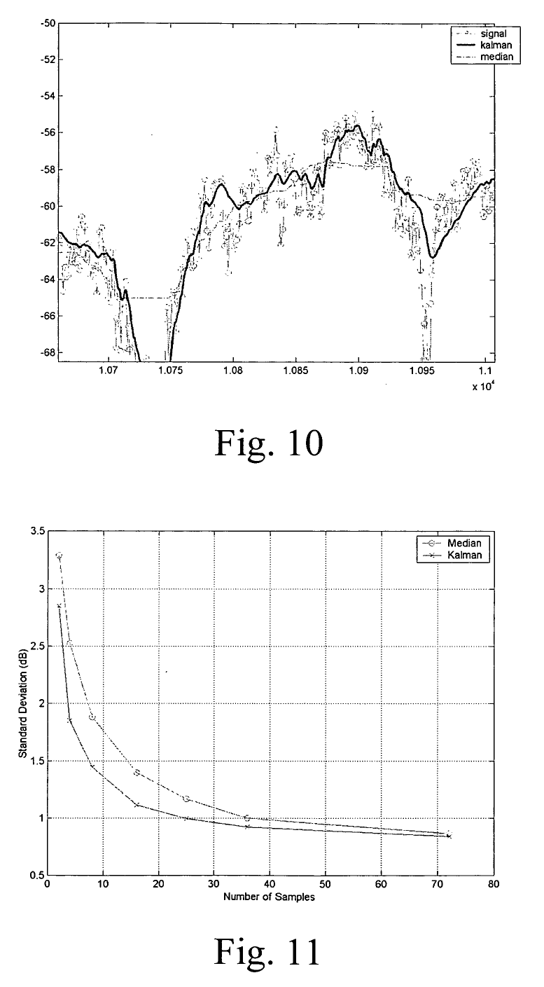

Indeed, FIGS. 9 and 10 illustrate the difference in tracking of the slow fading component of the signal strength data. In this example, because the user speed is known, the ‘x’ axis denotes distance, which can be easily converted to time. FIG. 9 illustrates signal strength data for a moving mobile terminal. The gray waveform indicates the signal strength data with both fast and slow fading components. The darker lines (which will be illustrated in more detail in FIG. 10) illustrate the median-filtered and adaptive Kalman-filtered signal strength data. FIG. 10 magnifies a small portion of the graph in FIG. 9 to reveal important details. Here, it is clear that the dashed line median filter does not closely track the actual slow faded signal strength waveform. Sharper valleys and peaks of the slow fading wave form are ignored. In contrast, the bold line, Kalman-filtered signal closely tracks the slowly faded signal strength waveform including tracking both sharpen valleys and hills in that waveform. Stated differently, the adaptive Kalman filtering approach gives point-by-point tracking and is much better at accurately representing slow faded signal strength, particularly in a rapidly changing communications environment such as can be found in mobile radio communications. Consider, for example, the change received in signal strength as a mobile radio being transported in an automobile takes a sharp turn around a large building or other obstruction. The actual signal strength may change dramatically as the automobile rounds that corner.

Another benefit of the adaptive Kalman filtering approach is that much less data is needed to support this filtering as compared to the median filtering method. FIG. 11 shows a graph of the standard deviation in dB as compared to a number of samples required for the median filtering and the Kalman filtering approaches. As can be seen in FIG. 11, for most cases, about half a number of samples are required for the Kalman filtering approach as compared to the median filtering approach. Thus, the Kalman filtering approach is more accurate and requires considerably less data to deliver that accuracy.

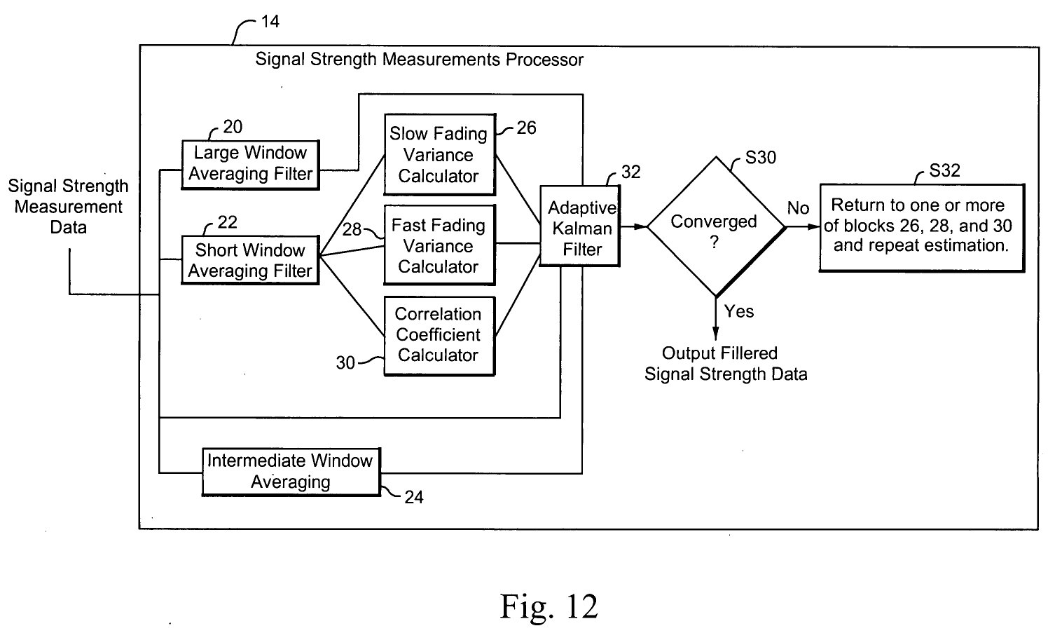

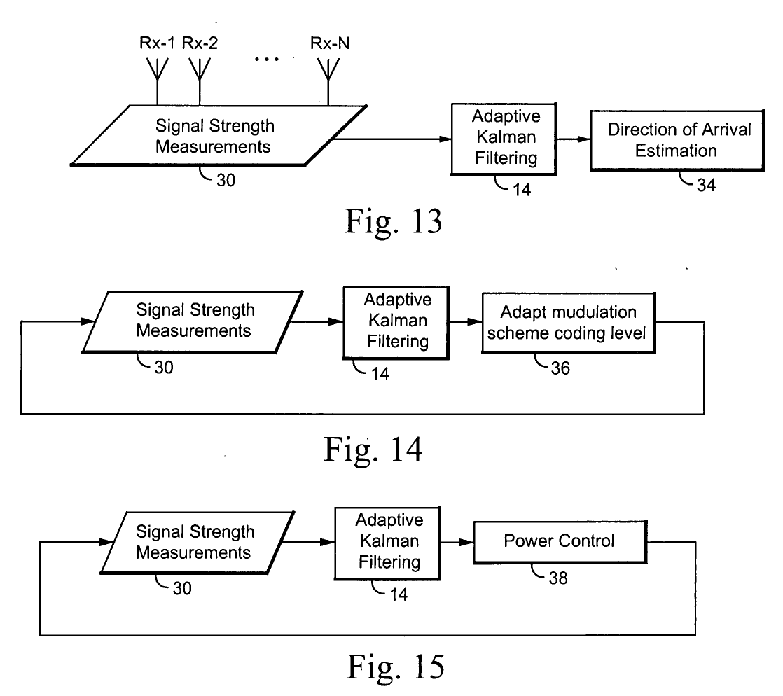

Another non-limiting example implementation of adaptive filtering is illustrated in FIG. 12. Here, the signal strength processor 14 is quite similar to that shown in FIG. 5 but with additional iterations performed. After the Kalman filter has generated a filter output, a decision can be made whether the Kalman filter has converged sufficiently by tracking the rate of change in the filtered signal between iterations. If so, the Kalman filter signal strength data is output to the management block 16. Otherwise, control returns to one or more of the calculator blocks 26, 28, and 30 to repeat the calculations made in those blocks. For these blocks, the process is repeated for the Kalman-filtered signal from the previous iteration (rather than the measured signal). Although this alternative example implementation may enhance the performance with better estimations, it would typically require additional computation time.

There are many advantageous applications for the adaptive Kalman filtering technology. In recent years, the impact of adaptive antennas and array processing to the overall performance of a wireless communication system has become very important. Adaptive or smart antennas include an antenna array combined with space and time diversity processing. The processing of signals from different antennas helps to improve performance both in terms of capacity and quality by, in particular, decreasing co-channel interference. A key issue for good performance for adaptive antenna systems is to have reliable reference inputs. These references include antenna array element positions and characteristics, direction of arrival information, planar properties, and the dimensionality of incoming radio signals. In particular, adaptive antenna systems require accurate estimations of the direction of arrival (DOA) for a desired received signal as well as interfering signals. Once the arrival directions are estimated accurately for these signals, then processing in space, time, or other domains may be accomplished in order to improve the systems performance.

While there are different approaches and algorithms for estimating direction of arrival with various complexities and resolutions, all these methods require averaging signal strength from different directions in order to remove the effects of noise and fast fading. Indeed, existing direction of arrival determination approaches rely on averaging the power levels for a given time interval, and once the power levels in each direction have been averaged, then the desired direction of arrival calculation algorithm is executed. Notably, the resolution performance is limited by the number of signal strength samples taken for averaging. As the number of samples increases, so does the delay in the system, which is typically undesirable in most telecommunication applications. But by using the adaptive Kalman filtering technology, the required number of samples for a given reliability is significant reduced, which decreases the delay.

FIG. 12 illustrates a non-limiting, example application of adaptive Kalman filtering applied to direction of arrival estimation. Signal strength measurements are obtained in block 30 from multiple receiver antennas Rx-1, Rx-2, . . . , Rx-N. The signal strengths are collected from various directions or angles of arrival and are filtered in the adaptive Kalman filtering block 14 to generate the average received power levels of the signals received from each direction. The average power levels received in each direction are then employed in a suitable DOA algorithm to estimate direction of arrival for each of the signals in block 34.

Another non-limiting example application of adaptive Kalman filtering of signal strength data is to adaptive modulation and/or coding. Signal strength estimation is important in the decision of modulation and coding of modem radio communication systems such as High Speed Downlink Packet Access (HSDPA), Worldwide Interoperability for Microwave Access (WiMAX), Long Term Evolution (LTE). In these adaptive architectures, the carrier-to-interference (C/I) levels as well as signal quality indicator (SQI) values are reported for each UE position. However, these C/I and SQI values should be filtered in order to remove the effects of fast fading.

FIG. 14 illustrates a block diagram applying adaptive Kalman filtering to adaptive modulation and/or coding assignments for a particular radio channel based upon signal strength measurements taken for that channel in block 30, filtered to remove fast fading in the adaptive Kalman filtering block 14, and then used to adapt the modulation scheme and/or coding level in block 36 applied to transmissions from a radio transmitter over that radio channel. Because the adaptive Kalman filtering significantly reduces the number of samples required to remove fast fading from signal strength measurements, faster modulation and/or coding assignments may be made. This results in more accurate and faster adaptation to current conditions on the radio channel, and ultimately, better performance and service.

Yet another non-limiting example application of adaptive Kalman filtering of signal strength data is to power control. For example, it has been shown that in CDMA systems, for various power control algorithms, a one dB reduction in local mean signal strength estimation may result in an accommodation of an additional five users. Since fast fading components change with distance on the order of wavelengths, local mean signal strength is used in many power control algorithms. Satellite communication systems are effected by fast fading as well, especially in the downlink. In these and in other situations, power control algorithms are employed to reduce transmitted power, (a very important resource) and reduce interference. In fact, any system that experiences fast fading and requires power control based on average signal strength levels can benefit from the adaptive Kalman filtering technique, unless the power control mechanism is fast enough to compensate for fast fading.

FIG. 15 shows a block diagram of one example application of adaptive Kalman filtering of signal strength data to power control. Signal strength measurements are determined for one or communications channels for which power control is to be implemented. The signal strength measurements are filtered in the adaptive Kalman filtering block 30 to remove fast fading components, and the filtered signal strength values are then processed in the power control block to determine appropriate power control commands for future transmissions over the one or more radio channels. By way of example, comparing the standard deviation for a lower number of samples, e.g., less than 10, the difference between median filtering and adaptive filtering may result in about one dB accuracy difference in the power control, which could translate into significant capacity increases depending on the scenario.

Although various embodiments have been shown and described in detail, the claims are not limited to any particular embodiment or example. None of the above description should be read as implying that any particular element, step, range, or function is essential such that it must be included in the claims scope. Reference to an element in the singular is not intended to mean “one and only one” unless explicitly so stated, but rather “one or more.” The scope of patented subject matter is defined only by the claims. The extent of legal protection is defined by the words recited in the allowed claims and their equivalents. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. No claim is intended to invoke paragraph 6 of 35 USC §112 unless the words “means for” or “step for” are used. Furthermore, no feature, component, or step in the present disclosure is intended to be dedicated to the public regardless of whether the feature, component, or step is explicitly recited in the claims.

1. A data processing method for processing signal measurement data associated with a received radio signal, where the signal measurement data includes a fast fading component and a slow fading component, including using an adaptive Kalman filtering process to filter out the fast fading component of the signal measurement data.

2. The method in claim 1, wherein the adaptive Kalman filtering process is an iterative process and uses multiple Kalman filtering variables whose values are estimated based on the signal measurements, the method further comprising:
determining an estimate of one or more of the multiple Kalman filtering variables for each iteration.

3. The method in claim 2, wherein the multiple Kalman filtering variables include a variance of the slow fading component.

4. The method in claim 2, wherein the multiple Kalman filtering variables include a variance of the fast fading component.

5. The method in claim 2, wherein the signal measurement data includes signal measurement data associated with a radio signal received at multiple different geographical positions, and wherein multiple Kalman filtering variables include a correlation coefficient associated with a degree of correlation between signal measurement data at each geographical position at a first time and signal measurement data at that geographical position at a second time.

6. The method in claim 2, further comprising:
determining that an output of the adaptive Kalman filtering process has yet to converge to a predetermined point, and
adapting one or more of the multiple Kalman filtering variables based on the output of the adaptive Kalman filtering process and performing another iteration of the adaptive Kalman filtering process based on the adaptation.

7. The method in claim 1, further comprising:
filtering the signal measurement data over a predetermined time period using a windowing technique to determine an averaged slow fading component of the signal measurement data, and
adapting a Kalman filtered result by replacing a slow fading component of the Kalman filtered data with the averaged slow fading component.

8. The method in claim 1, wherein the signal measurement data includes a signal strength of the received radio signal at multiple different geographical positions.

9. The method in claim 8, wherein the adaptive Kalman filtering process includes:
determining an a priori estimate of the signal strength at each of the geographical positions based on a previously-determined signal strength at each of the geographical positions;
determining an a posteriori prediction of a minimum mean square error (MMSE) of a previous determination of the signal strength at each of the geographical positions based on variances and power levels of the fast fading and slow fading components;
determining a Kalman filtering gain based on the determined a posteriori prediction of MMSE and an estimate of a variance of the fast fading component; and
determining a Kalman-filtered output based on the a priori estimate, the Kalman filtering gain, and an average signal strength of the received radio signal at multiple different geographical positions.

10. A method for use in filtering measurement data associated with received radio signals, comprising:
processing the measurement data;
from the processed measurement data, calculating an estimate of one or more filtering variables;
Kalman filtering the measurement data using the estimated one or more filtering variables; and
using the Kalman-filtered measurement data in managing a communications network.

11. The method in claim 10, further comprising:
in a next iteration, processing updated measurement data;
calculating a new estimate of one or more filtering variables from the updated measurement data, and
Kalman filtering the updated measurement data using the new estimate of one or more filtering variables.

12. The method in claim 11, wherein the Kalman filtering is used to filter out a fast fading component in the measurement data associated with received radio signals.

13. The method in claim 10, wherein the signal measurement data includes a signal strength of the received radio signal at multiple different geographical positions, and wherein the filtered measurement data is used to determine direction of arrival information for the received radio signal at the multiple different geographical positions.

14. The method in claim 10, wherein the signal measurement data includes signal strength of the received radio signal at multiple different geographical positions, and wherein the filtered measurement data is used to adapt a modulation method or a coding method used to transmit radio signals to at least some of the multiple different geographical positions.

15. The method in claim 10, wherein the signal measurement data includes a signal strength of the received radio signal at multiple different geographical positions, and wherein the filtered measurement data is used to control transmit power levels used to transmit radio signals to at least some of the multiple different geographical positions.

16. Apparatus for processing signal measurement data associated with a received radio signal, where the signal measurement data includes a fast fading component and a slow fading component, comprising an adaptive Kalman filtering processor configured to filter out the fast fading component of the signal measurement data.

17. The apparatus in claim 16, wherein the adaptive Kalman filtering processor is configured to:
perform an iterative process;
use multiple Kalman filtering variables whose values are estimated based on the signal measurements; and
determine an estimate of one or more of the multiple Kalman filtering variables for each iteration.

18. The apparatus in claim 17, wherein the multiple Kalman filtering variables include a variance of the slow fading component.

19. The apparatus in claim 17, wherein the multiple Kalman filtering variables include a variance of the fast fading component.

20. The apparatus in claim 17, wherein the signal measurement data includes signal measurement data associated with a radio signal received at multiple different geographical positions, and wherein multiple Kalman filtering variables include a correlation coefficient associated with a degree of correlation between signal measurement data at each geographical position at a first time and signal measurement data at that geographical position at a second time.

21. The apparatus in claim 17, wherein the adaptive Kalman filtering processor is configured to:
determine that an output of the adaptive Kalman filtering processor has yet to converge to a predetermined point, and
adapt one or more of the multiple Kalman filtering variables based on the output of the adaptive Kalman filtering process and performing another iteration of the adaptive Kalman filtering process based on the adaptation.

22. The apparatus in claim 17, wherein the adaptive Kalman filtering processor is configured to:
filter the signal measurement data over a predetermined time period using a windowing technique to determine an averaged slow fading component of the signal measurement data, and
adapt a Kalman-filtered result by replacing a slow fading component of the Kalman filtered data with the averaged slow fading component.

23. The apparatus in claim 17, wherein the signal measurement data includes a signal strength of the received radio signal at multiple different geographical positions.

24. The apparatus in claim 23, wherein the adaptive Kalman filtering processor is configured to:
determine an a priori estimate of the signal strength at each of the geographical positions based on a previously-determined signal strength at each of the geographical positions;
determine an a posteriori prediction of a minimum mean square error (MMSE) of a previous determination of the signal strength at each of the geographical positions based on variances and power levels of the fast fading and slow fading components;
determine a Kalman filtering gain based on the determined a posteriori prediction of MMSE and an estimate of a variance of the fast fading component; and
determine a Kalman-filtered output based on the a priori estimate, the Kalman filtering gain, and an average signal strength of the received radio signal at multiple different geographical positions.

25. Apparatus for use in filtering measurement data associated with received radio signals, comprising:
initial processing circuitry for processing the measurement data;
calculating circuitry for calculating an estimate of one or more filtering variables from the processed measurement data;
a Kalman filter for Kalman filtering the measurement data using the estimated one or more filtering variables; and
an output terminal for providing the Kalman-filtered measurement data for use in one or more communications network management functions.

26. The apparatus in claim 25, wherein the initial processing circuitry is configured to process updated measurement data in a next filtering iteration,
wherein the calculating circuitry is configured to calculate a new estimate of one or more filtering variables from the updated measurement data, and
wherein the Kalman filter is configured to Kalman filter the updated measurement data using the new estimate of one or more filtering variables.

27. The apparatus in claim 25, wherein the Kalman filter is configured to filter out a fast fading component in the measurement data associated with received radio signals.

28. The apparatus in claim 25, wherein the signal measurement data includes a signal strength of the received radio signal at multiple different geographical positions, further comprising:
means for determining direction of arrival information for the received radio signal at the multiple different geographical positions based on the filtered measurement data.

29. The apparatus in claim 25, wherein the signal measurement data includes a signal strength of the received radio signal at multiple different geographical positions, further comprising:
means for adapting a modulation method or a coding method used to transmit radio signals to at least some of the multiple different geographical positions based on the filtered measurement data.

30. The apparatus in claim 25, wherein the signal measurement data includes a signal strength of the received radio signal at multiple different geographical positions, further comprising:
means for controlling transmit power levels used to transmit radio signals to at least some of the multiple different geographical positions based on the filtered measurement data.
